(19) United States
(12) Patent Application Publication
(10) Pub. No.: US 2025/0383672 A1
(43) Pub. Date: Dec. 18, 2025

(54) METHOD FOR PROCESSING POSE INFORMATION IN AN AT LEAST PARTIALLY AUTOMATED VEHICLE AND/OR ROBOT

(71) Applicant: MERCEDES-BENZ GROUP AG, Stuttgart (DE)

(72) Inventors: Christopher MONACO, Sunnyvale, CA (US); Umair SIDDIQUE, San Jose, CA (US)

(21) Appl. No.: 18/877,641

(22) PCT Filed: Jun. 30, 2023
(86) PCT No.: PCT/EP2023/068049

§ 371 Date: Dec. 20, 2024

(30) Foreign Application Priority Data
Jun. 30, 2022 (DE) 10 2022 206 725.8

(51) Int. Cl. G05D 1/85; B60W 30/09; B60W 50/02; B60W 60/00; G05D 1/246

(52) U.S. Cl. CPC G05D 1/85; B60W 30/09; B60W 50/0205; B60W 50/0225; B60W 60/0059; G05D 1/246; B60W 2552/10; B60W 2554/4041; B60W 2555/60; B60W 2556/40

(57) ABSTRACT

A method (100) for processing vehicle and/or robot pose information in an at least partially automated vehicle (50), a driving assistance system (60) of the vehicle (50), and/or a robot (70), comprising the steps of: ⋅determining (110), based at least in part on measurement data (1) gathered by at least one sensor that is carried by the vehicle (50) and/or robot (70), a pose (2) of the vehicle (50) and/or robot (70), as well as maximum expected errors (2a) of at least the pose (2); ⋅querying (120), based at least in part on the position comprised in the determined pose (2), an alert limit service (3) for position-dependent, and optionally also orientation-dependent, maximum permissible errors (4); ⋅determining (130) whether the maximum expected errors (2a) are within the maximum permissible errors (4); and ⋅if the maximum expected errors (2a) exceed the maximum permissible errors (4), initiating (160) at least one remedial action.

The invention relates to the monitoring and/or controlling of an least partially automated vehicle, a driving assistance system of the vehicle, and/or a robot.

### BACKGROUND

A vehicle or a robot that moves in an at least partially automated manner needs accurate knowledge of its own present location and orientation in order to plan its next actions. Also, the correct functioning of many driving assistance systems is dependent on the knowledge of the location and orientation. The combination of the location and orientation is termed “pose”. The pose is computed from measurement data that is gathered by sensors carried by the vehicle and/or robot.

Together with the pose itself, a pose uncertainty is determined. This pose uncertainty is checked against alert limits. If the alert limits are exceeded, safe autonomous operation is no longer possible, and autonomous operation is therefore disengaged.

Setting alert limits requires balancing between catching all potentially unsafe situations on the one hand, and avoiding an overly high false alarm rate on the other hand. This is explained in detail in (T. G. R. Reid et al., “Localization Requirements for Autonomous Vehicles”, arXiv: 1906.0106v1 (2019).

### DISCLOSURE OF THE INVENTION

The invention provides a method for processing vehicle and/or robot pose information in an at least partially automated vehicle, a driving assistance system of the vehicle, and/or a robot.

The method starts with determining, based at least in part on measurement data gathered by at least one sensor that is carried by the vehicle and/or robot, a pose of the vehicle and/or robot, as well as maximum expected errors of at least the pose. For example, the maximum expected errors may comprise a pose uncertainty. But on top of this, the maximum expected errors may also relate to other quantities.

Based at least in part on the position comprised in the determined pose, an alert limit service is queried for position-dependent, and optionally also orientation-dependent, maximum permissible errors. For example, these maximum permissible errors may relate to the same quantities to which the maximum expected errors relate. But maximum permissible errors may also, for example, relate to an aggregate of quantities to which maximum expected errors relate. For example, a maximum permissible error may stipulate that the sums of lateral pose uncertainties in the three Cartesian directions in meters and an angular pose uncertainty in degrees is at most a certain amount. In the field of at least partially automated driving, the maximum permissible error is commonly referenced to as the “alert limit”, and the maximum expected error is commonly referred to as the “protection level”.

As it will be discussed below, the consequence of making the maximum permissible errors location-dependent is that they more accurately vary with the dependency of an actual risk for the vehicle and/or robot on the maximum expected errors. In this manner, if the maximum expected errors exceed the maximum permissible errors, this is correlated with a risk, and a remedial action is warranted.

Thus, the method goes on with determining whether the maximum expected errors are within the maximum permissible errors.

If the maximum expected errors are within the maximum permissible errors, an actuation signal may be computed based at least in part on the determined pose. The vehicle, the driving assistance system, and/or the robot, may then be actuated with this actuation signal. If, however, the maximum expected errors exceed the maximum permissible errors, at least one remedial action is initiated. In particular, the remedial action may comprise causing a disengaging of the autonomous operation of the vehicle, the robot, and/or the driving assistance system. The system then enters a “system unavailable” state. For example, a human driver may be prompted to take over control of the vehicle. But the remedial action may also, for example, comprise activating more sensors or an advanced signal processing in order to improve the accuracy of its pose.

The inventors have found that one and the same maximum expected error has very different effects on the safety of the vehicle and/or robot depending on the concrete traffic situation. Driving scenarios are unique; they correspond to widely varying road geometries and pose-based risk. For example, it is largely inconsequential if a vehicle has 10 m of longitudinal uncertainty along a long, straight highway. However, it is very dangerous if a vehicle has 10 m of longitudinal uncertainty on a two-way curved road. Similarly, a small heading error yields minimal consequences on wide highway lanes. Yet, that same heading error could be dangerous if it causes the vehicle to incorrectly associate a green traffic light with the one for its own lane.

Thus, the risk that emanates from a given maximum expected error is location-dependent due to the road geometry, as well as due to the presence of traffic lights, traffic signs and other objects. This information is more or less static, so that, in a good approximation, the risk given a particular uncertainty is a function of location only, and not a function of the time.

In a particularly advantageous embodiment, the alert limit service comprises at least one map and/or database in which maximum permissible errors, and/or precursors for the computation of the maximum permissible errors, are stored. For example, a standard map that is also used for navigation of the vehicle and/or robot may be given an additional layer with maximum permissible errors and/or precursors. In this manner, the maximum permissible errors can be obtained much more quickly than by computing them on-demand, because the computations are quite complex. The computation is time-critical because an at least partially automated vehicle and/or robot may have a maximum fault tolerant time of up to 500 ms in some applications, but only on the order of 1-10 ms in other applications. This is the time for which a fault can be present in the system before the safe state can change to unsafe. Computing power is at a premium on board a vehicle, especially if the hardware is required to have a high safety integrity level, SIL.

In this context, “precursor” means an intermediate result in the process of calculating the maximum permissible errors from the location from which the sought maximum permissible errors can be computed much more quicker than from the location. For example, a precursor may be useful to address a dependency of the maximum permissible errors on a variable that is quickly computed on-the-fly, but would result in a very high memory usage if stored in the map and/or database. In a simple example, if the computation of the maximum permissible errors involves a division by the friction coefficient of the road as a final step, and this friction coefficient can take 100 different values, it is more efficient to save a precursor that comprises all computation steps except this final division in the map and/or database, and compute the final division on-the-fly. Storing the complete, ready-to use maximum permissible errors for all 100 possible values of the friction coefficient would take 100 times as much memory.

Maximum permissible errors and/or precursors may additionally be procured from other sources. For example, on top of a first map and/or database on board the vehicle and/or robot, there may be a second map and/or database in the cloud that has a chance of being more up-to-date. There are then different possible ways to combine the different sources of maximum permissible errors and/or precursors.

In a particularly advantageous embodiment, at least one map and/or database is located on board the vehicle and/or robot. The map and/or database is then always available, even if a network connection to a more up-to-date source is not available.

In one exemplary embodiment, the maximum permissible errors, and/or the precursors, stored in the at least one map and/or database may represent the strictest possible maximum permissible errors that may be rendered more lenient by maximum permissible errors and/or precursors from other sources. In this manner, if the other sources beside the first map and/or database are unavailable, a “worst-case estimate” of the maximum permissible errors is used for a maximum level of safety. If the other sources are available, their more up-to-date information may indicate that the maximum permissible errors may be relaxed. For example, maximum permissible errors in a map and/or database in the cloud may be continuously updated in order to account for a current density of traffic, road conditions, or weather conditions. For example, on a dry road in summertime, the maximum permissible errors may be more relaxed than on an iced-over road in wintertime. Also, the risk that emanates from a given maximum expected error may also depend on the density of traffic around the vehicle and/or robot.

In another exemplary embodiment, the maximum permissible errors, and/or the precursors, stored in the at least one map and/or database may represent the most lenient possible maximum permissible errors that may be rendered stricter by maximum permissible errors and/or precursors from other sources. This embodiment is easier to review for regulatory approval. For example, a map and/or database on board the vehicle and/or robot may be approved, and further changes may then be locked out. Even if a user of the vehicle then augments this map and/or database with other sources for maximum permissible errors, the behavior of the vehicle will never get worse than according to the first, approved map and/or database.

In particular, the alert limit service may comprise a cloud service that delivers, based at least in part on the position, maximum permissible errors and/or precursors. Such a cloud service, may, for example, comprise one or more further maps and/or databases. But alternatively or in combination to this, it may also perform computations of the maximum permissible errors on-the-fly. For example, a car may, in its basic form, operate based on a local map and/or database that imposes very strict maximum permissible errors. On-the-fly computation in the cloud, which takes much computing power but drastically improves the driving experience, may then be rented by the hour as a fee-paying extra.

In a further advantageous embodiment, based at least in part on measurement data gathered by at least one sensor that is carried by the vehicle and/or robot, a plausibility check as to whether the information obtained from the map and/or database on board the vehicle and/or robot is still accurate is performed. The information that is checked in this manner need not be limited to the maximum permissible errors and/or precursors. Rather, geographic features, such as road geometry, may be included in the plausibility check as well. Because the risk emanating from a given maximum expected error may depend on such geometric features, if the geometric features are no longer accurate, the maximum permissible errors and/or precursors in the map may be no longer accurate either.

If the checked information is found to be still accurate, it is used to determine the sought maximum permissible errors. However, if this information is found to be no longer accurate, the cloud service is queried for up-to-date maximum permissible errors and/or precursors.

Preferring a querying of the on-board map and/or database in this manner saves data connection fees for querying the cloud service. Also, the cloud service itself may be a pay-per-use service, so preferring the use of the local source saves unnecessary usage fees here as well.

In an alternative embodiment, the cloud service is queried first, and the map and/or database on board the vehicle and/or robot is queried if the cloud service is not available. In this embodiment, the cloud service is presumed to provide more up-to-date and/or more accurate, and the local source is used as a back-up only.

In a further advantageous embodiment, the maximum permissible errors may be modified based at least in part on
the mass, and/or the mass distribution, of the vehicle and/or robot, and/or
the dimensions of a load that extends beyond the vehicle and/or robot.

For example, a larger mass of the vehicle slows down the reaction of the vehicle to any steering or braking action. Also, if the vehicle is made more top-heavy by adding a load to the roof, an overly hash steering action may cause the vehicle to tip over.

A load that extends beyond the vehicle may decrease the margin of safety between the vehicle and any areas that the vehicle is not supposed to enter, such as a lane for oncoming traffic.

The invention also provides a localization module for an at least partially automated vehicle, a driving assistance system of the vehicle, and/or a robot. This localization module comprises an interface that is configured to read in measurement data gathered by at least one sensor that is carried by the vehicle and/or robot. Processing means of the localization module are configured to determine, based at least in part on the measurement data, a pose of the vehicle and/or robot, as well as maximum expected errors of at least the pose.

Furthermore, an integrity monitoring submodule is provided. This integrity monitoring submodule is configured to:
determine maximum permissible errors by querying the maximum permissible errors, and/or precursors for their computation, from a local map and/or database, and/or from a cloud service;
compare the maximum expected errors with the maximum permissible errors; and
in response to determining that the maximum expected errors exceed the maximum permissible errors, cause a disengaging of the autonomous operation of the vehicle, the robot, and/or the driving assistance system.

This localization module may take the place of a previously used localization module. It brings about the advantage that the cases in which the autonomous operation is disengaged correspond more accurately to the cases where the maximum expected errors are really too high in view of the concrete traffic situation and the level of acceptable risk. An existing localization module may be upgraded to become a localization module according to the present invention by inserting said integrity monitoring submodule, or changing out an old integrity monitoring submodule with a new one that can make queries to a local map and/or database, and/or to a cloud service.

The invention also relates to a method for determining maximum permissible errors of at least the pose of a vehicle and/or robot that is to move in an at least partially automated manner, and/or that is to be assisted by a driving assistance system.

This method starts with providing a map of the area in which the vehicle and/or robot is to be operated, wherein this map comprises at least the geometry of roads and/or paths on which the vehicle and/or robot is to travel. For each of a set of possible positions that are reachable by the vehicle and/or robot, based at least in part on features from the map, a correlation between a risk that the vehicle and/or robot is implicated in at least one undesired event on the one hand, and maximum expected errors of at least the pose of the vehicle and/or robot on the other hand given that the vehicle and/or robot is at this location.

Based at least in part on this correlation and a predetermined maximum allowable risk level for the undesired event, the sought maximum permissible errors, and/or precursors for their computation are determined.

That is, the features of the map give away how the risk increases with an increasing maximum expected error. By means of this dependency, the given predetermined maximum allowable risk level translates into maximum permissible errors.

In a particularly advantageous embodiment, the correlation is based at least in part on a distance of at least of a portion of the vehicle and/or robot to an area where the presence of this portion of the vehicle and/or robot can cause the at least one undesired event. For example, the road geometry decides which type of uncertainty is how likely to bring about a collision risk with other traffic by virtue of the vehicle leaving its lane. For example, on a long straight road, a longitudinal pose uncertainty is less likely to cause the vehicle to leave its lane than in a curve.

One possible factor in the correlation is the distance available for stopping the vehicle, e.g., at a red traffic light or at a stop sign. The farther the vehicle is still away from the point where it has to stop, the better it is possible to correct any errors due to a pose uncertainty and the more pose uncertainty is thus allowable. But if the vehicle is very close to the point where it has to stop, even a minor uncertainty can cause it to overshoot that point.

Going hand in hand with this are vehicle deceleration limits. These vehicle deceleration limits decide over when the vehicle really must start slowing down before a point which it is not to pass.

Thus, one undesired event that is to be avoided may be entry of the vehicle and/or robot into an area where other traffic participants have priority, such as an intersection where other traffic has the right of way, or even a green traffic light. If the other traffic relies on its right of way, unauthorized entry to said area carries a high risk of a collision. But even if there is no collision, there are penalties for running stop lights or red traffic lights.

A collision of the vehicle and/or robot with at least one other traffic participant or other object is an undesired event that is to be avoided as such, no matter of how it is caused. I.e., it is to be avoided even if the root cause is another driver doing something wrong.

Another undesired event is a mis-association of traffic signs and/or traffic lights that are valid for another lane of traffic to the lane of traffic travelled by the vehicle and/or robot. Although it is largely ignored in the research literature, the localization pose estimate is critical for establishing associations between sensed and map features. This is particularly important if the sensed features have a real-time signal, like traffic lights. Consequently, it is safety critical that the localization pose estimate is within its error/uncertainty bounds. For example, a slight heading error could cause the adjacent green traffic light to be associated with the traffic light for the vehicle's current lane. This could be extremely dangerous if the vehicle's lane actually has a red traffic light; the vehicle will continue driving into an intersection when it should stop instead. Therefore, the risk of incorrectly associated traffic lights should constrain the vehicle's maximum permissible errors when it is approaching intersections.

Likewise, a mis-association of a traffic participant that travels in another lane of traffic to the lane of traffic travelled by the vehicle and/or robot is another undesired event. For example, if an oncoming vehicle is incorrectly detected as coming at the own vehicle and/or robot head-on, this may incorrectly cause an emergency braking or evasion maneuver.

Likewise, a mis-association of a traffic participant to the wrong lane of traffic is another undesired event. A correct pose estimate is critical for associating surrounding traffic participants to traffic lanes within the map. The reference line of a traffic participant's lane provides a strong prior for predicting the participants future. Therefore, a mis-association may corrupt the prediction and subsequent collision avoidance. For example, it could hinder an evasive maneuver or trigger unwarranted emergency braking.

The methods may be wholly or partially computer-implemented. The invention therefore also relates to a computer program with machine-readable instructions that, when executed by one or more computers and/or compute instances, cause the one or more computers and/or compute instances to perform one of the methods described above. Examples for compute instances include virtual machines, containers or serverless execution environments in a cloud. The invention also relates to a machine-readable data carrier and/or a download product with the computer program. A download product is a digital product with the computer program that may, e.g., be sold in an online shop for immediate fulfilment and download to one or more computers. The invention also relates to one or more compute instances with the computer program, and/or with the machine-readable data carrier and/or download product.

### DESCRIPTION OF THE FIGURES

In the following, the invention is illustrated using Figures without any intention to limit the scope of the invention. The Figures show:

FIG. 1 Exemplary embodiment of the method 100 for processing vehicle and/or robot pose information in an at least partially automated vehicle 50, a driving assistance system 60 of the vehicle 50, and/or a robot 70;

FIG. 2 Exemplary illustrations how maximum permissible errors may vary in different situations;

FIG. 3 Exemplary embodiment of the localization module;

FIG. 4 Exemplary embodiment of the method 200 for determining maximum permissible errors.

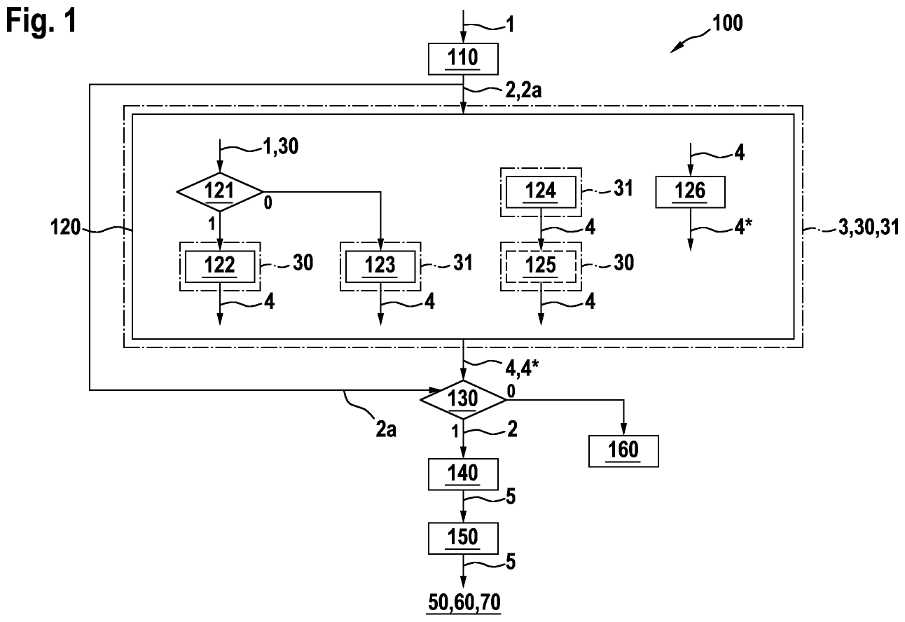

FIG. 1 is a schematic flow chart of an exemplary embodiment of the method 100 for processing vehicle and/or robot pose information in an at least partially automated vehicle 50, a driving assistance system 60 of the vehicle 50, and/or a robot 70.

In step 110, based at least in part on measurement data 1 gathered by at least one sensor that is carried by the vehicle 50 and/or robot 70, a pose 2 of the vehicle 50 and/or robot 70, as well as an maximum expected errors 2a of at least the pose 2, are determined.

In step 120, based at least in part on the position comprised in the determined pose 2, an alert limit service 3 is queried for position-dependent, and optionally also orientation-dependent, maximum permissible errors 4. In particular, this alert limit service 3 may comprise at least one map 30 and/or database in which maximum permissible errors 4, and/or precursors for the computation of the maximum permissible errors 4, are stored. It may also comprise at least one cloud service 31.

According to block 121, based at least in part on measurement data 1 gathered by at least one sensor that is carried by the vehicle 50 and/or robot 70, a plausibility check may be performed as to whether the information obtained from the map 30 and/or database on board the vehicle 50 and/or robot 70 is still accurate. If the information is found to be still accurate, it may be used, according to block 122, to determine the sought maximum permissible errors 4. By contrast, if the information is found to be no longer accurate, according to block 123, the cloud service 31 may be queried for up-to-date maximum permissible errors 4 and/or precursors for their computation.

According to block 124, the cloud service 31 may be queried first. If this cloud service 31 is not available, according to block 125, the map 30 and/or database on board the vehicle 50 and/or robot 70 may be queried.

Irrespective of how exactly the sought maximum permissible errors 4 are obtained, they may be modified, according to block 126, based at least in part on
the mass, and/or the mass distribution, of the vehicle 50 and/or robot 70, and/or
the dimensions of a load that extends beyond the vehicle 50 and/or robot 70.

The modified version of the maximum permissible errors is labelled with the reference sign 4*.

In step 130, it is determined whether the maximum expected errors 2a are within the maximum permissible errors 4. If this is the case (truth value 1), in step 140, based at least in part on the determined pose 2, an actuation signal 5 is computed. In step 150, the vehicle 50, the driving assistance system 60, and/or the robot 70, is then actuated with this actuation signal 5. However, if the maximum expected errors 2a are not within the maximum permissible errors 4 (truth value 0 at diamond 130), in step 160, a remedial action is taken. For example, this remedial action may comprise disengaging autonomous operation and entering a “system unavailable” mode.

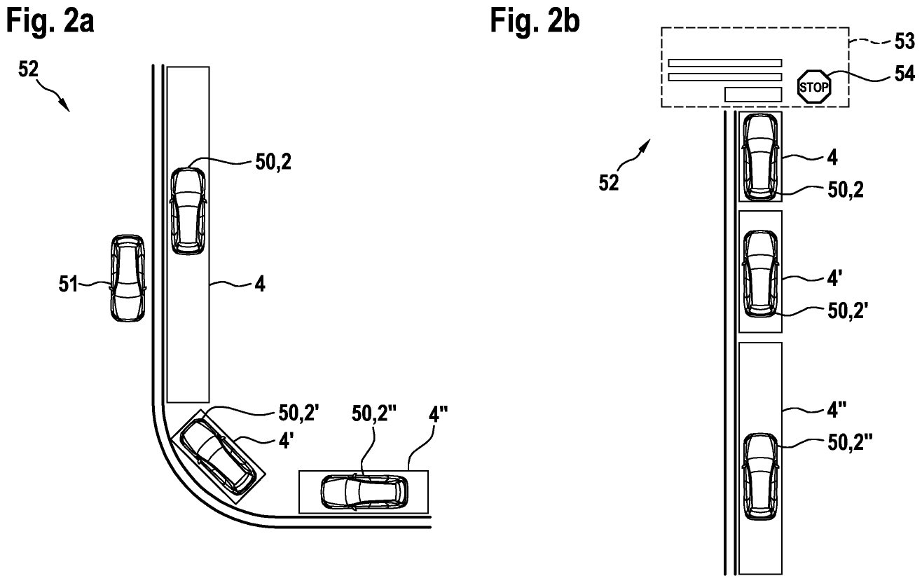

FIG. 2 illustrates on three examples how the determined maximum permissible errors 4, 4′, 4″ may vary in different traffic situations.

FIG. 2a shows a first example. In this example, the vehicle 50 travels a road 52. The road 52 is a two-way road; there is another oncoming vehicle 51 in the oncoming lane beyond the central divider of the road 52. This first example illustrates the dependency of the maximum permissible errors 4 on road geometry.

When the vehicle 50 is in pose 2 on a long, straight stretch of the road 52, a longitudinal uncertainty in the direction of travel is largely inconsequential. Therefore, the maximum permissible error 4 for the longitudinal component of the pose 2 is rather high. The maximum permissible error 4 for the lateral component of the pose 2 perpendicular to the direction of travel is much lower because it is important that the vehicle 50 stays in lane.

When the vehicle 50 is in pose 2′ in a bend of the road 52, the maximum permissible error 4 for the lateral component of the pose 2′ is unchanged. The maximum permissible error 4′ for the longitudinal component of the pose 2′ needs to be much lower because such an uncertainty might cause the vehicle 50 to cross the central divider of the road 52.

When the vehicle 50 is in pose 2″ on a shorter straight stretch of the road 52 before said bend, the maximum permissible error 4″ for the longitudinal component of the pose 2″ is higher than the corresponding maximum permissible error 4′ in pose 2′ in the bend. However, it is a lot lower than the maximum permissible error 4 in pose 2 on the much longer straight stretch of the road 52.

FIG. 2b shows a second example. In this example, the road 52 leads to an intersection 53 that is protected with a stop sign 54. This second example illustrates the dependency of the maximum permissible errors 4 on the distance available for stopping.

When the vehicle 50 is in pose 2 immediately before the intersection, the maximum permissible error 4 for the longitudinal component of the pose 2 is low because such uncertainty might cause the vehicle to pass the stop line of the stop sign 54. In poses 2′ and 2″, the maximum permissible error 4′, 4″ for the longitudinal component of the pose 2′, 2″ increases with the distance that is still available for stopping before the intersection 53. The maximum permissible error 4, 4′, 4″ for the lateral component of the pose 2, 2′, 2″ perpendicular to the direction of travel is always the same, so as to ensure that the vehicle 50 keeps in lane.

FIG. 2c shows a third example. In this example, the road 52 with two lanes 52a and 52b leads to an intersection 53 again, but the intersection 53 is now protected with traffic lights 54a and 54b that are associated with lanes 52a and 52b, respectively. This third example illustrates how the maximum permissible error for the orientation may vary when approaching the intersection 53.

When the vehicle 50 is in pose 2, it is critical that it does not mis-interpret the green traffic light 54b that is valid for another vehicle 51 as being valid for vehicle 50, causing this vehicle 50 to run the red light 54a. Therefore, the maximum permissible error 4 for the orientation is very low. Farther away from the intersection 53, when the vehicle 50 is in pose 2′, the maximum permissible error 4′ for the orientation can be relaxed considerably.

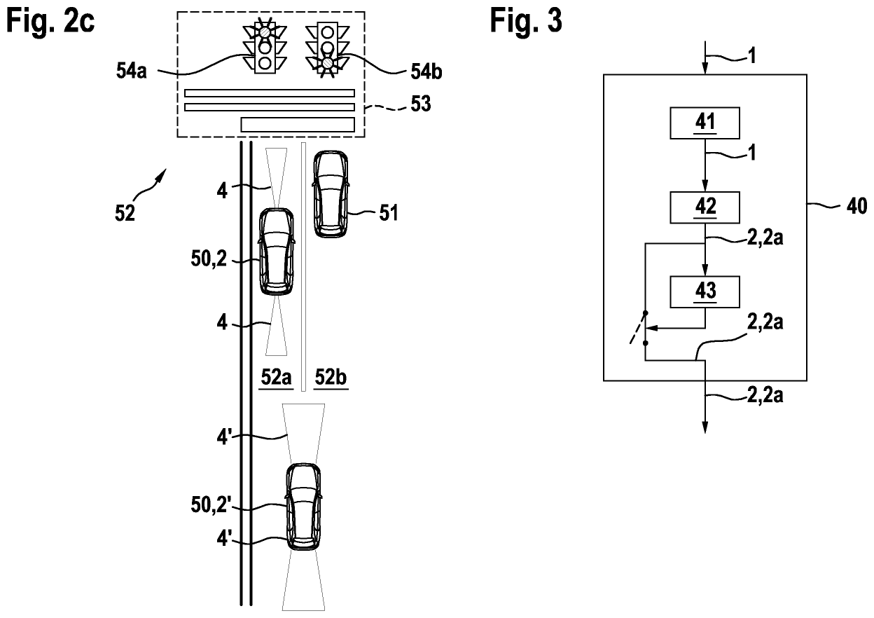

FIG. 3 is a schematic illustration of an embodiment of the localization module 40. The localization module 40 takes in measurement data 1 and outputs a pose 2 of the vehicle 50 and/or robot 70, including maximum expected errors 2a of at least the pose 2.

An interface 41 of the localization module 40 is configured to read in measurement data 1 gathered by at least one sensor that is carried by the vehicle 50 and/or robot 70. Processing means 42 of the localization module 40 are configured to determine, based at least in part on the measurement data, a pose 2 of the vehicle 50 and/or robot 70, as well as maximum expected errors 2a of at least the pose 2.

An integrity monitoring submodule 43 of the localization module 40 is configured to determine maximum permissible errors 4 by querying the maximum permissible errors 4, and/or precursors for their computation, from a local map 30 and/or database, and/or from a cloud service 31. The determined maximum expected errors 2a are compared with the maximum permissible errors 4. If the maximum permissible errors 4 are exceeded, the autonomous operation of the vehicle 50, the robot 70, and/or the driving assistance system 60, is disengaged. This implies that in this case, the pose 2 and maximum expected errors 2a will no longer be provided to downstream systems of the vehicle 50, the robot 70, and/or the driving assistance system 60 for use.

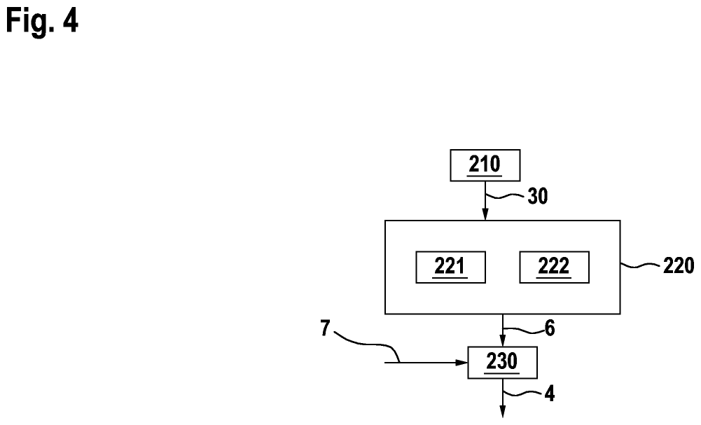

FIG. 4 is a schematic flow chart of an embodiment of the method 200 for determining maximum permissible errors 4 of at least a pose 2 of a vehicle 50 and/or robot 70 that is to move in an at least partially automated manner, and/or that is to be assisted by a driving assistance system 60.

In step 210, a map 30 of the area in which the vehicle 50 and/or robot 70 is to be operated is provided. This map 30 comprises at least the geometry of roads and/or paths on which the vehicle 50 and/or robot 70 is to travel.

For each of a set of possible positions that are reachable by the vehicle 50 and/or robot 70, a correlation 6 between a risk that the vehicle 50 and/or robot 70 is implicated in at least one undesired event on the one hand, and maximum expected errors 2a of at least the pose 2 of the vehicle 50 and/or robot 70 on the other hand, are determined in step 220.

According to block 221, the correlation 6 may be based at least in part on a distance of at least of a portion of the vehicle 50 and/or robot 70 to an area where the presence of this portion of the vehicle 50 and/or robot 70 can cause the at least one undesired event.

According to block 222, the undesired event may comprise one or more of:
entry of the vehicle 50 and/or robot 70 into an area where other traffic participants have priority;
a collision of the vehicle 50 and/or robot 70 with at least one other traffic participant or other object;
a mis-association of traffic signs and/or traffic lights that are valid for another lane of traffic to the lane of traffic travelled by the vehicle 50 and/or robot 70; and
a mis-association of a traffic participant that travels in another lane of traffic to the lane of traffic travelled by the vehicle 50 and/or robot 70.

In step 230, based at least in part on this correlation 6 and a predetermined maximum allowable risk level 7 for the undesired event, the sought maximum permissible errors 4, and/or precursors for their computation, are determined.

### LIST OF REFERENCE SIGNS

1 measurement data
2, 2′, 2″ pose of vehicle 50 and/or robot 70
2a maximum expected errors
3 alert limit service
30 map of alert limit service 3
31 cloud service of alert limit service 3
4, 4′, 4″ maximum permissible errors
4* modified version
5 actuation signal
6 correlation between risk and maximum expected errors 2a
7 maximum allowable risk level
40 localization module
41 interface of localization module 40
42 processing means of localization module 40
43 integrity monitoring submodule of localization module 40
50 vehicle
51 other vehicle
52 road
52a, 52b lanes of road 52
53 intersection
54 stop sign
54a, 54b traffic lights
60 driving assistance system
70 robot
100 method for controlling vehicle 50, system 60, robot 70
110 determining pose 2 and maximum expected errors 2a
120 querying alert limit service 3
121 performing plausibility check
122 using plausible information to determine maximum permissible error 4
123 querying cloud service 31
124 querying cloud service 31 first
125 querying map 30 if cloud service 31 not available
126 modifying alert limits 4
130 determining whether expected error 2a is within permissible error 4
140 computing actuation signal 5
150 actuating systems 50, 60, 70 with actuation signal 5
160 initiating remedial action
200 method for determining maximum permissible errors 4
210 providing map 30
220 determining correlation 6
221 specific way of determining correlation 6
222 specific undesired events
230 determining maximum permissible errors 4

1. A method for processing vehicle and/or robot pose information in an at least partially automated vehicle, a driving assistance system of the vehicle, and/or a robot, comprising the steps of:
determining, based at least in part on measurement data gathered by at least one sensor that is carried by the vehicle and/or robot, a pose of the vehicle and/or robot, as well as maximum expected errors of at least the pose;
querying, based at least in part on the position comprised in the determined pose, an alert limit service for position-dependent, and/or orientation-dependent, maximum permissible errors;
determining whether the maximum expected errors are within the maximum permissible errors; and
if the maximum expected errors exceed the maximum permissible errors, initiating at least one remedial action.

2. The method of claim 1, further comprising the step of: if the maximum expected errors are within the maximum permissible error, computing, based at least in part on the determined pose, an actuation signal, and actuating the vehicle, the driving assistance system, and/or the robot, with the actuation signal.

3. The method of claim 1, wherein the alert limit service comprises at least one map and/or database in which maximum permissible errors, and/or precursors for the computation of the maximum permissible errors, are stored.

4. The method of claim 3, wherein the at least one map and/or database is located on board the vehicle and/or robot.

5. The method of claim 3, wherein the maximum permissible errors, and/or the precursors, stored in the at least one map and/or database represent:
the strictest possible maximum permissible errors that may be rendered more lenient by maximum permissible errors and/or precursors from other sources, or
the most lenient possible maximum permissible errors that may be rendered stricter by maximum permissible errors and/or precursors from other sources.

6. The method of claim 1, wherein the alert limit service comprises a cloud service that delivers, based at least in part on the position, maximum permissible errors and/or precursors.

7. The method of claim 6, wherein the alert limit service comprises at least one map and/or database in which maximum permissible errors, and/or precursors for the computation of the maximum permissible errors, are stored; and wherein the at least one map and/or database is located on board the vehicle and/or robot; the method further comprising:
performing, based at least in part on measurement data gathered by at least one sensor that is carried by the vehicle and/or robot, a plausibility check as to whether the information obtained from the map and/or database on board the vehicle and/or robot is still accurate; and
if the information is found to be still accurate, using it to determine the sought maximum permissible errors; and
if the information is found to be no longer accurate, querying the cloud service for up-to-date maximum permissible errors and/or precursors.

8. The method of claim 6, wherein the alert limit service comprises at least one map and/or database in which maximum permissible errors, and/or precursors for the computation of the maximum permissible errors, are stored; and wherein the at least one map and/or database is located on board the vehicle and/or robot; and wherein the cloud service is queried first, and the map and/or database on board the vehicle and/or robot is queried if the cloud service is not available.

9. The method of claim 1, further comprising:
modifying the maximum permissible errors based at least in part on the mass, and/or the mass distribution, of the vehicle and/or robot; and/or
the dimensions of a load that extends beyond the vehicle and/or robot.

10. A localization module for an at least partially automated vehicle, a driving assistance system of the vehicle, and/or a robot, comprising:
an interface configured to read in measurement data gathered by at least one sensor that is carried by the vehicle and/or robot,
processing means configured to determine, based at least in part on the measurement data, a pose of the vehicle and/or robot, as well as maximum expected errors of at least the pose, and
an integrity monitoring submodule that is configured to:
determine maximum permissible errors by querying the maximum permissible errors, and/or precursors for their computation, from a local map and/or database, and/or from a cloud service;
compare the determined maximum expected errors with the maximum permissible errors; and
in response to determining that the maximum expected errors exceed the maximum permissible errors, cause a disengaging of the autonomous operation of the vehicle, the robot, and/or the driving assistance system.

11. A method for determining maximum permissible errors of at least a pose of a vehicle and/or robot that is to move in an at least partially automated manner, and/or that is to be assisted by a driving assistance system, the method comprising the steps of:
providing a map of the area in which the vehicle and/or robot is to be operated, wherein this map comprises at least the geometry of roads and/or paths on which the vehicle and/or robot is to travel; and for each of a set of possible positions that are reachable by the vehicle and/or robot:
determining, based at least in part on features from the map, a correlation between a risk that the vehicle and/or robot is implicated in at least one undesired event on the one hand, and maximum expected errors of at least the pose of the vehicle and/or robot on the other hand; and
determining, based at least in part on this correlation and a predetermined maximum allowable risk level for the undesired event, the sought maximum permissible errors, and/or precursors for their computation.

12. The method of claim 11, wherein the correlation is based at least in part on a distance of at least of a portion of the vehicle and/or robot to an area where the presence of this portion of the vehicle and/or robot can cause the at least one undesired event.

13. The method of claim 11, wherein the undesired event comprises one or more of:
entry of the vehicle and/or robot into an area where other traffic participants have priority;
a collision of the vehicle and/or robot with at least one other traffic participant or other object;
a mis-association of traffic signs and/or traffic lights that are valid for another lane of traffic to the lane of traffic travelled by the vehicle and/or robot; and
a mis-association of a traffic participant that travels in another lane of traffic to the lane of traffic travelled by the vehicle and/or robot.

14. A non-transitory computer-readable medium for storing a computer program, the computer program comprising machine-readable instructions that, when executed by one or more computers and/or compute instances, upgrade the one or more computers and/or compute instances to an integrity monitoring submodule that is configured to:
determine maximum permissible errors by querying the maximum permissible errors, and/or precursors for their computation, from a local map and/or database, and/or from a cloud service;
compare the determined maximum expected errors with the maximum permissible errors; and
in response to determining that the maximum expected errors exceed the maximum permissible errors, cause a disengaging of the autonomous operation of the vehicle, the robot, and/or the driving assistance system; and cause the one or more computers and/or compute instances to perform a method according to claim 1.

14. (canceled)

15. (canceled)

17. A non-transitory computer-readable medium for storing a computer program, the computer program comprising machine-readable instructions that, when executed by one or more computers and/or compute instances, upgrade the one or more computers and/or compute instances to an integrity monitoring submodule that is configured to:
determine maximum permissible errors by querying the maximum permissible errors, and/or precursors for their computation, from a local map and/or database, and/or from a cloud service;
compare the determined maximum expected errors with the maximum permissible errors; and
in response to determining that the maximum expected errors exceed the maximum permissible errors, cause a disengaging of the autonomous operation of the vehicle, the robot, and/or the driving assistance system;
and cause the one or more computers and/or compute instances to perform a method according to claim 11.

18. A non-transitory computer-readable medium for storing a computer program, the computer program comprising machine-readable instructions that, when executed by one or more computers and/or compute instances, cause the one or more computers and/or compute instances to perform a method according to claim 1.

19. A non-transitory computer-readable medium for storing a computer program, the computer program comprising machine-readable instructions that, when executed by one or more computers and/or compute instances, cause the one or more computers and/or compute instances to perform a method according to claim 1.
